(19) United States
(12) Patent Application Publication
(10) Pub. No.: US 2004/0196500 A1
(43) Pub. Date: Oct. 7, 2004

(54) Image forming apparatus for forming images based on communication data received

(75) Inventor: Toru Ichiki, Sagamihara-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/705,276

(22) Filed: Nov. 10, 2003

(30) Foreign Application Priority Data
Nov. 18, 2002 (JP) JP2002-333945

(51) Int. Cl. G06F 15/00; H04N 1/00

(52) U.S. Cl. 358/1.15; 358/402

(57) ABSTRACT

An image forming apparatus includes: a device for creating an identification electronic mail for demanding the image data processing format to be set, by notifying that a facsimile communication data to be sent to a predetermined electronic mail address has been received, and also image data identification data; a transmission and reception device for transmitting the identification electronic mail to a predetermined external terminal and for receiving the instruction electronic mail containing an instruction on the processing format for image data and identification data to identify the image data from the external terminal; an electronic mail processor for extracting an instruction on the image data processing format from an external terminal; and an image data processor for sending to the image output device an output image data which is obtained by processing so that the image data specified according to the extracted processing format is outputted according to the processing format.

### BACKGROUND OF THE INVENTION

The present invention relates to an image forming apparatus for forming images based on communication data received in conformity to the communications procedures by facsimile or by electronic mail.

In a conventional facsimile machine or multifunctional machine having both facsimile and printing functions, an image received by the facsimile or electronic mail is automatically stored in a memory once, and the operation section of the image forming apparatus is operated to make sure that the image is stored into the memory. Then such processing as hard copying or printing out is carried out as required.

In the aforementioned apparatus having the conventional facsimile functions, in order to check if the facsimile information has been received or not, it is necessary to go to the place where the apparatus is installed.

The Official Gazette of Japanese Patent Tokkai 88644-1999 proposes a facsimile transfer method that allows the incoming facsimile information to be received by a portable remote terminal or portable PC, in order to eliminate the aforementioned inconvenience where the facsimile information received by a facsimile machine cannot be read because there is no one close to the machine.

According to the aforementioned Official Gazette of Japanese Patent Tokkai 88644-1999, the received facsimile information is stored in a predetermined server. Then an electronic mail containing this facsimile information attached thereto in the form of an attached file is sent to the pre-registered electronic mail address, thereby ensuring the facsimile information to be transferred.

When this method is used, however, the receiver of transfer is fixed to a particular address, and flexible action cannot be taken when the receiver must be changed.

The Official Gazette of Japanese Patent Tokkai 322538-1998 proposes a facsimile apparatus and a method for automatic sorting of the facsimile based on the receiver designated by a sender of facsimile information.

This Official Gazette of Japanese Patent Tokkai 322538-1998 proposes a facsimile apparatus conforming to a predetermined format, wherein the identification information registered in advance for identification of the receiver, for example, an identification number is included in transmission information by a facsimile sender, and the identification number, for example, is dialed. This identification information is picked up by the receiver having received this facsimile information and the receiver corresponding to that identification information is designated. Then the received facsimile information is sent to this receiver.

However, if the facsimile apparatus does not conform to the format, facsimile information cannot be transferred. Even if the facsimile apparatus conforms to the format, the facsimile information cannot be transferred when the sender does not know the identification information of a desired receiver for transfer. Furthermore, when-the-receiver must be changed, change of the receiver is accompanied by difficulties.

### SUMMARY OF THE INVENTION

In view of the prior art described above, it is an object of the present invention to provide an image forming apparatus characterized in that processing of the received facsimile such outputting and transfer is carried out according to the designation given by the remote operation of a receiving party, and processing conditions can be changed in an flexible manner.

To solve the aforementioned problems, the image forming apparatus of the present invention comprises: communication means for performing communications with an external apparatus according to the communications procedure by facsimile; data processing means for picking up image data and communications control data by decoding the facsimile communication data from the aforementioned external apparatus received by the aforementioned communication means; memory means for storing the image data obtained by the aforementioned image data processing means, by associating it with the identification data to identify the image data; image output means for forming and outputting an image based on the aforementioned image data; identification electronic mail creating means for creating the identification electronic mail for demanding the image data processing format to be set, by notifying that, when communications control data has been gained by the aforementioned data processing means, facsimile communication data to be sent to a predetermined electronic mail address has been received, and also by notifying image data identification data; transmission and reception means for transmitting the aforementioned identification electronic mail to a predetermined external terminal and for receiving the instruction electronic mail containing the instruction on the processing format for image data and the identification data from the external terminal; electronic mail processing means for extracting the instruction on the image data processing format and the identification data from the instruction electronic mail from the aforementioned external terminal; and image data processing means for sending to the image output means an output image data which is obtained by processing so that the image data specified according to the extracted processing format is outputted according to the processing format.

It is preferred that a transmission table be provided to store the electronic mail address associated with the transmitter of the facsimile communication data included in the aforementioned communications control data, and the aforementioned identification electronic mail means extract the electronic mail address where the identification electronic mail is sent by referring to the transmission table based on the transmission transmitter, thereby creating the identification electronic mail.

It is preferred to provide a processing table for storing the transmitter of the facsimile communication data included in the aforementioned communications control data, and the information on whether the image data corresponding to this communications control data should be sent to the image output means or the memory means, wherein the aforementioned transmitter and the aforementioned information are associated with each other, in such a way that the aforementioned data processing means sends the image data to a predetermined receiver by referring to the processing table, based on the aforementioned transmitter.

When the identification electronic mail is created by the aforementioned identification electronic mail, it is preferred to provide input means for specifying a desired identification electronic mail receiver.

### BRIEF DESCRIPTION OF THE DRAWINGS

FIG. 1 is a block diagram representing an image forming apparatus as one embodiment of the present invention;

FIG. 2 is a diagram representing a facsimile reception operation as the aforementioned embodiment of the present invention;

FIG. 3 is a flow chart representing the operation of each component at the time of facsimile reception operation as the aforementioned embodiment of the present invention;

FIG. 4 is a diagram representing an example of reception management information placed under the management of the aforementioned embodiment of the present invention;

FIG. 5 is a diagram representing an example of receiving transaction information placed under the management of the aforementioned embodiment of the present invention;

FIG. 6 is a diagram representing an example of the header information of facsimile communication data received in the aforementioned embodiment of the present invention;

FIG. 7 is a diagram representing an example of the configuration of a directory of the image memory in the aforementioned embodiment of the present invention;

FIG. 8 is a flowchart showing the procedure for creating an identification electronic mail in the aforementioned embodiment of the present invention; and

FIG. 9 is a diagram representing an example of the aforementioned identification electronic mail.

### DETAILED DESCRIPTION OF THE PREFERRED EMBODIMENT

The following describes the preferred embodiments of the present invention with reference to the drawings:

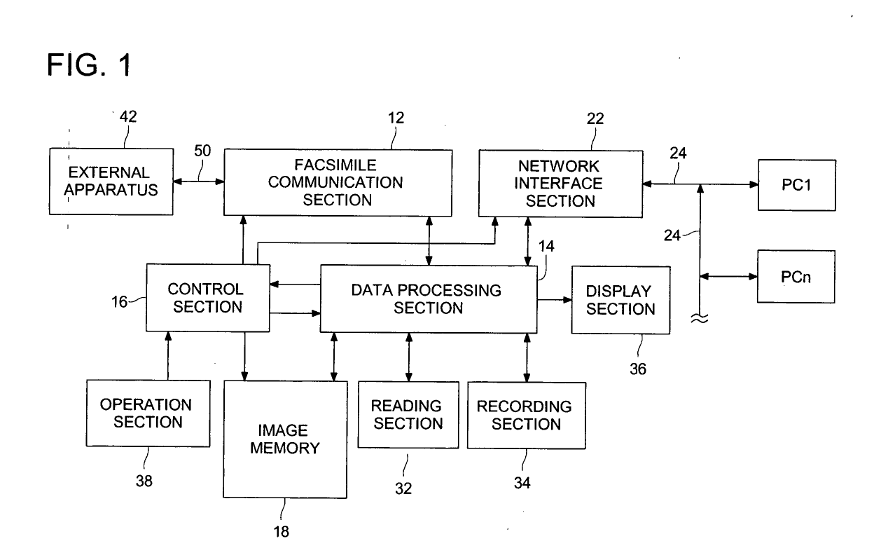

As shown in FIG. 1, the aforementioned image forming apparatus comprises: a facsimile communication section 12 as communication means for performing communications with an external apparatus 42 according to the communications procedure by facsimile; a data processing section 14 as data processing means for picking up image data and communications control data by decoding the facsimile communication data from the aforementioned external apparatus received by the aforementioned communication means; an image memory 18 as memory means for storing the image data obtained by the aforementioned image data processing means, by associating it with the identification data corresponding to the image data; a recording section 34 as image output means for forming and outputting an image based on the aforementioned image data; a control section 16 as identification electronic mail creating means for creating the identification electronic mail for demanding the image data processing format to be set, by notifying that, when communications control data has been gained by the aforementioned data processing means, facsimile communication data to be sent to a predetermined electronic mail address has been received, and also by notifying image data identification data; a network interface (IF) section 22 as transmission and reception means for transmitting the aforementioned identification electronic mail to a predetermined external terminal and for receiving the instruction electronic mail containing the instruction on the processing format for image data from the external terminal; a data processing section 14 as electronic mail processing means for extracting the instruction on the image data processing format from the instruction electronic mail from the aforementioned external terminal; and a data processing section 14 as image data processing means for sending the output image data to the aforementioned-image output means, wherein this output image data is obtained by processing the image data specified according to the aforementioned extracted processing format so that it will be outputted according to this processing format.

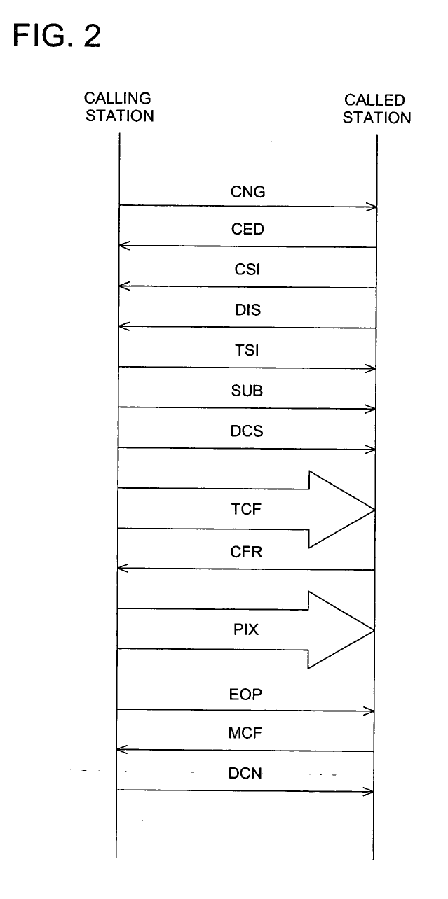

As shown in FIG. 2, the facsimile communication section 12 performs communications according to a predetermined procedure, and receives facsimile communication data sent from the external apparatus 42 via a telephone line 50.

FIG. 2 shows a communications protocol used between general facsimile apparatuses.

In FIG. 2, a calling station makes a phone call to a called station, and then sends a CNG signal (calling station identification signal) to notify that it is a calling station for facsimile.

The called station sends a CED signal (called station terminal identification signal), CSI signal (called station identification signal) and DIS (digital identification signal) to the calling station to notify that it is the called station for facsimile.

Upon receipt of the DIS signal from the called station, the calling station realized that the other party is a facsimile machine, and sends a TSI signal (transmitting station identification signal), SUB signal (transmission sub-address identification signal) and DCS (digital command signal). It then sends a TCF signal (training check signal).

The called station performs training in the mode specified by the DCS signal, and sends a CFR signal (reception preparation identification signal) if the result is satisfactory.

Upon receipt of the CFR signal, the calling station sends an image signal (PIX) on the first page. On completion of the image data for one page, it sends an EOP signal (end-of-procedure signal).

Upon receipt of the EOP signal, the called station completes processing of the one-page data, and sends an MCF signal (message identification signal).

Upon receipt of the MCF signal, the calling station determines that the other party has received the image data, and sends DCN signal (line disconnect signal) to disconnect the line.

The facsimile communication section 12 decodes the received facsimile communication data, and sends it to the data processing section 14 after the data has been converted into the processible data by the image forming apparatus. It also sends it to the external apparatus 42 via the telephone line 50 according to the instruction from the control section 16.

The data processing section 14 receives the data decoded by the facsimile communication section 12. Communication data such as the data for specifying the resolution, data size and transmitter of the communication data from the facsimile communication section 12 is sent separately from this decoded data.

The data processing section 14 sends the aforementioned communications control data to the control section 16. according to the operation instruction from the control section 16 to be described later and the instructions contained in the instruction electronic mail sent through the network 24 and network interface section 22, the data processing section 14, the aforementioned image data applies compression or other processing as required, and sends it to the image memory 18 or sends the image data to the recording section 34 as an image output means and display section 36.

When the communications control data has been sent from the data processing section 14, the control section 16 determines that the facsimile communication data has been received, and creates the image data identification data such as a file name in the image data corresponding to this communications control data. It also-creates an identification electronic mail to the effect that the facsimile communication data has been received and that this identification data is notified, and sends this electronic mail to the network interface section 22.

When the image data gained by the data processing section 14 is stored in the image memory 18, the control section 16 gives instructions to the data processing section 14 to send the image data to the image memory 18, and gives instructions to the image memory 18 to store the image data to be sent.

Further, when the image data is outputted by the recording section 34 or display section 36, it gives instructions to the data processing section 14 to send the image data to at least one of the recording section 34 and display section 36.

It is good practice to predetermine to which of the image memory 18, recording section 34 and display section 36 the image data should be sent, or to determine it by inputting from the display section 36 as required. Alternatively, the receiver may be included in the received facsimile communication data or in the instruction electronic mail (to be described later) from external terminals PC 1 through PC n.

When the data is forwarded to the external apparatus 42 such as a facsimile apparatus other than the transmitter of the facsimile communication data, instructions are given to the data processing section 14 to send the image data to the facsimile communication section 12, and instructions are given to the facsimile communication section 12 to code the image data and to send it to the external apparatus 42 through the telephone line 50.

According to the image data storage instruction sent from the control section 16, the image memory 18 stores the image data sent from the data processing section 14. When there is a request to send back a predetermined image data from the data processing section 14, the predetermined data out of the stored image data is sent to the data processing section 14 according to the request.

The network interface section 22 is an interface for connection between the image forming apparatus and external terminals PC 1 through PC n. It sends the identification electronic mail to a predetermined external terminal through the network 24, where the aforementioned identification electronic mail contain information for notifying that the facsimile communication data has been received.

The network interface section 22 receives the instruction electronic mail sent from the external terminals PC 1 through PC n, and transfers it to the data processing section 14.

The network 24 includes a predetermined network, e.g., Local Area Network (LAN) and Wide Area Network (WAN).

The reading section 32 is a scanner, for example. It reads the document, creates image data and sends it to the data processing section 14.

The recording section 34 creates job data from the image data and output format data, and outputs a paper medium based on this job data. Here the output format data includes the data on the output medium size, scaling factor as well as presence or absence of a staple. These factors can be determined by inputting from the operation section 38 or can be set in advance. Alternatively, they can be contained in the facsimile communication data or in the instruction electronic mail from the external terminal.

The display section 36 is used to display the image data. It can also be used to indicate the operation procedure and operation status of the operation section 38, or to indicate the contents of image data for identification, prior to printing out from the recording section 34.

In addition to the operations required for the operation of the prior art image forming apparatus, the operation section 38 is required to input the output format data required for creation of the aforementioned job data, to input the operation for demanding the image output, and to provide a predetermined input for creation and transmission of the identification electronic mail as required. The operation section 38 includes a touch panel, keyboard and numeric keypad. When an identification electronic mail is created by the control section 16 as means for creating the aforementioned electronic mail, the operation section 38 is preferred to work as input means for desired designation of the receiver of this identification electronic mail.

The external apparatus 42 is an apparatus capable of facsimile communications such as a facsimile machine and computer system connected to the facsimile communication section 12 of this image forming apparatus through the telephone line 50.

The external terminals PC 1 through PC n allows electronic mail communications with the computer system or the like connected to the network interface section 22 of this image forming apparatus through the network 24. The external terminal having received the identification electronic mail creates the instruction electronic mail including the command for specifying the method of processing the image data to be identified, and sends it to the network interface section 22 through the network 24.

In the image forming apparatus shown in FIG. 1, it is preferred that a transmission table be provided to store the electronic mail address associated with the transmitter of the facsimile communication data included in the aforementioned communications control data, in such a way that the control section 16 as the aforementioned identification electronic mail creation means extracts the electronic mail address for sending the identification electronic mail by referring to the aforementioned transmission table based on the aforementioned transmitter of transmission.

It is preferred that a processing table be provided to associate the transmitter of sending the facsimile communication data contained in the aforementioned communications control data, with the information on whether the image data corresponding to this communications control data should be sent to the recording section 34 as the aforementioned image output means or to the image memory 18 of the aforementioned memory means, and to store these associated information items, in such a way that the data processing section 14 as the aforementioned data processing means sends the image data to the predetermined receiver by referring to the processing table based on the transmitter of transmission.

These transmission table and processing table (not illustrated) are arranged to allow access from the control section 16. Further, the transmission table and processing table are subjected to change, addition or deletion by the operation from the operation section 38. It is preferred that these table be updated by the control section 16 as required, according to the instruction sent from the external portion such as an external terminal having a predetermined authority, e.g. the description of the electronic mail.

In the conventional method, it is difficult to meet the need of urgent changes in cases where the operator of an external terminal as the receiver is away from the external terminal, for example, when the receiver of the identification electronic mail is fixed. The receiver of the identification electronic mail can be easily changed by updating the description of the table by changing, addition or deletion, without changing the system itself. This method allows the operator to send the identification electronic mail to the most convenient external terminal.

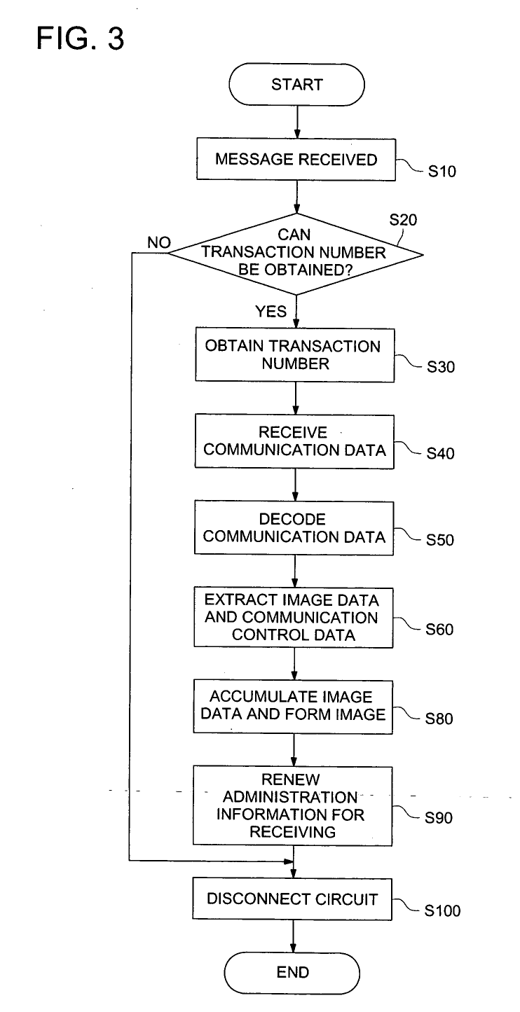

The following describes the operation procedure of the aforementioned image forming apparatus. FIG. 3 shows the flowchart.

In step S10, the facsimile communication section 12 receives facsimile information from the external apparatus 42.

In step S20, evaluation is made to see if a transaction number can be obtained or not, when the received facsimile information is processed by this image forming apparatus.

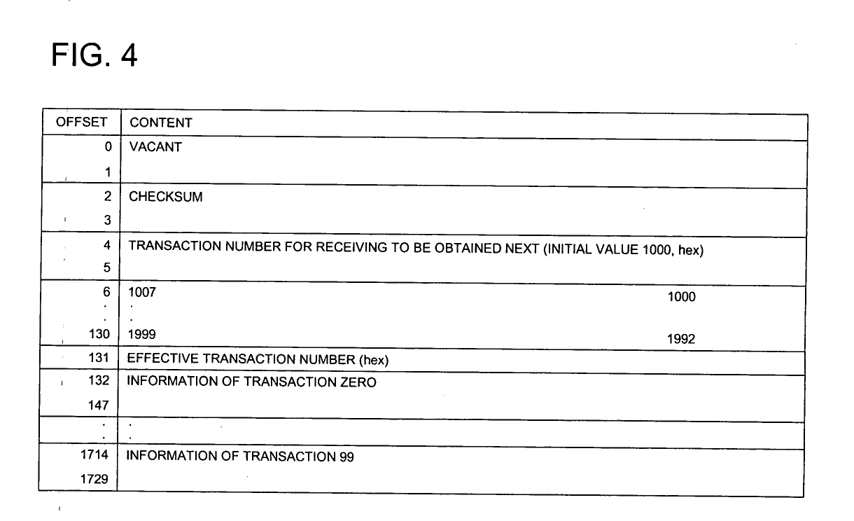

In the prior art facsimile machine (not illustrated) is provided with a nonvolatile memory to store and manage the received information. The contents of such nonvolatile memory consist of the contents added to each offset value, as shown in FIG. 4.

When the facsimile communication has started, reference is made to the “TRANSACTION NUMBER FOR RECEIVING TO BE OBTAINED NEXT” to make evaluation to see whether or not the (OFFSET VALUE 4), the offset value corresponding to this referred number, corresponds to other ones used as transaction number for receiving. In FIG. 4, the initial value of the transaction number for receiving is “1000”, and the maximum value is “1999”. The offset value corresponding to it is set at 6 through 130.

If the result of this evaluation is NO, i.e. the referred offset value does not correspond to the already used transaction number for receiving, the system proceeds to step S30.

If the result of this evaluation is YES, i.e. the referred offset value corresponds to the already used transaction number for receiving, the system proceeds to one higher offset value to see if the transaction number for receiving corresponding to a new offset value is already used or not. If the result of this evaluation is NO, the system proceeds to step S30. If the result of this evaluation is YES, the system proceeds to another still higher offset value to see if the transaction number for receiving corresponding to a new offset value is already used or not.

In this manner, the system sequentially proceeds to up to the maximum of the offset values (130 in FIG. 4) assigned as transaction numbers for receiving. If the transaction number for receiving is already used in this maximum of the offset values, the system goes back to the offset value corresponding to the initial value (6 in FIG. 4), and the work of receiving terminates. Evaluation is made to determine whether or not there is any VACANT transaction number for receiving. When it has been determined that the transaction numbers for receiving are already used for all offset values, the system goes to step S100.

In step S30, the transaction number for receiving corresponding to the last evaluated offset number is captured as the transaction number for that facsimile communications, and the system goes to step S40.

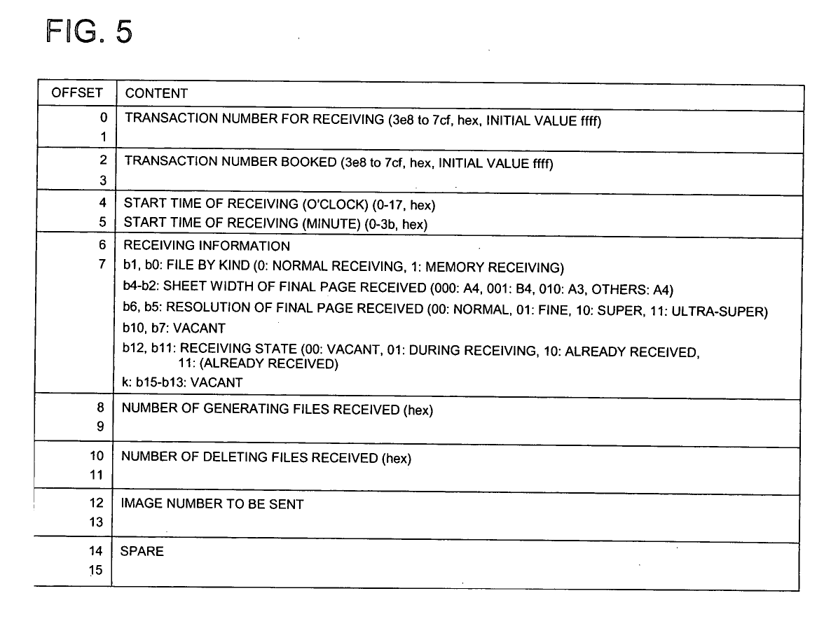

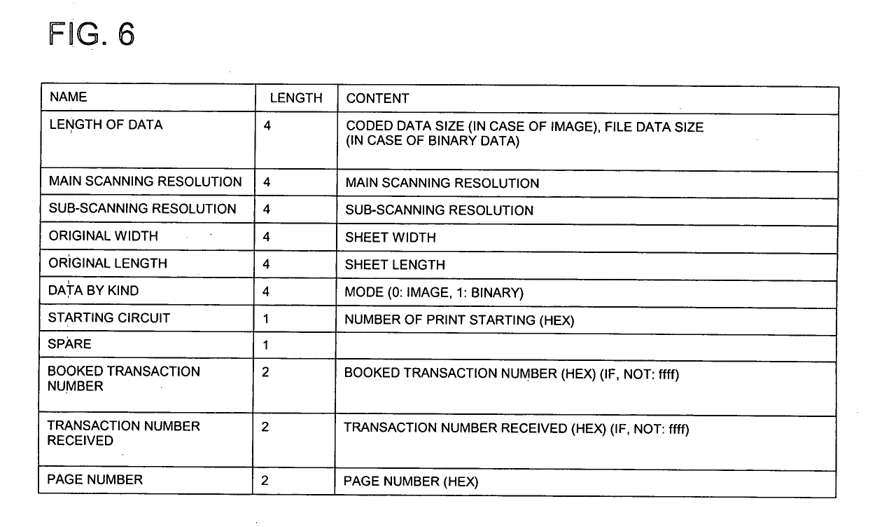

The transaction number for receiving is managed for each transaction number for receiving, as shown in FIG. 5. This information is also updated by capturing of the transaction number for receiving in step S30. As shown in FIG. 5, this transaction number for receiving consists of START TIME OF RECEIVING (offset values 4 and 5), RECEIVING INFORMATION (offset values 6 and 7), NUMBER OF GENERATING FILES RECEIVED (offset values 8 and 9), NUMBER OF DELETING FILES RECEIVED (offset values 10 and 11) and IMAGE NUMBER TO BE SENT (offset values 12 and 13). In step S40, facsimile communication data by the facsimile communication section 12 is sent and received. The header information on reception is such that shown in FIG. 6.

In step S50, processing of decoding by facsimile communication section 12 is carried out in order to convert the facsimile communication data into the data that can be processed by the data processing section 14.

In step S60, image data and communications control data are picked up from the facsimile communication data decoded in the data processing section 14, and the communications control data is sent to the control section 16. Then the system goes to step S80.

In step S80, the control section 16 gives instruction to the image memory 18 to secure the space for image data to be stored. Then instructions are given to data processing section 14 to send the image data to the image memory 18. The image data is stored in the image memory 18. The image data is printed out by the recording section 34 or is displayed on the display section 36. The system then goes to step S90.

In step S90, the transaction number for receiving at the time of reception as shown in FIG. 5 is created when the image data is stored. This is used as management information to update the reception management information as shown in FIG. 4. Then the system goes to step S100.

To put it more-specifically, starting from the top of FIG. 5, the transaction number obtained at the time of communication is set. Start time of receiving is determined by setting the current time of the day is picked up at the time of starting reception at the time of starting reception. Further, the type of the file (normal receiving or memory receiving type) is set as receiving information. The sheet width and resolution of final page received are set.

The receiving information is set at the time of starting reception and during reception, and the ALREADY RECEIVED is set when the final page has been received. The number of generating files received is 0 at the time of starting reception, and is incremented upon reception of every page.

Further, the CHECKSUM at the top in FIG. 4 is updated.

In step S100, the line used for facsimile communication is disconnected to terminate facsimile communications operation.

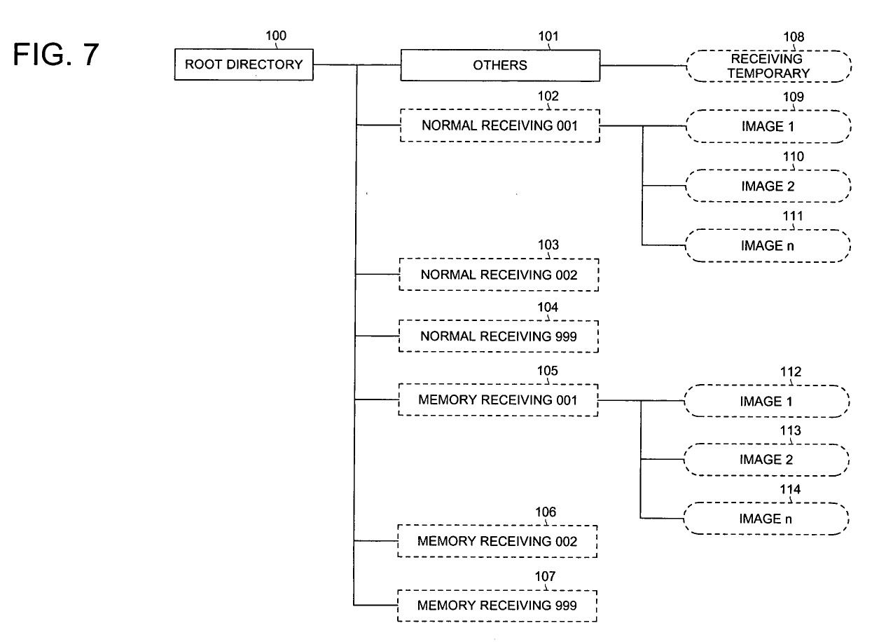

The following describes how to store the image data in the image memory 18. An example of file configuration is schematically given in FIG. 7.

FIG. 7 shows how the resident directory of “OTHERS” 101 is provided in the root directory. Further, a non-resident directory is provided for “NORMAL RECEIVING 001” 102, “NORMAL RECEIVING 002” 103, “MEMORY RECEIVING 999” 104, “MEMORY RECEIVING 001” 105, “MEMORY RECEIVING 002” 106 and “MEMORY RECEIVING 999” 107. Further, a subdirectory is provided one level lower in these directories. For example, a non-resident directory of “RECEIVING TEMPORARY” 108 is provided in the resident directory of “OTHERS”, non-resident directories of “IMAGE 1-n” 109, 110 and 111 in the directory of “NORMAL RECEIVING 001” respectively, and “IMAGE 1-n” 112, 113 and 114 in the directory of “MEMORY RECEIVING 001”, respectively.

It should be noted in passing that a non-resident directory is created every time the facsimile communication data has been received. The resident directory is always provided regardless of whether the facsimile communication data is received or not.

When there is a facsimile incoming call and facsimile communication data has been received, a non-resident directory of “RECEIVING TEMPORARY” is created below the resident directory of “OTHERS” in the image memory 18 according to the instruction from the control section 16, and the data processing section 14 sends the facsimile communication data decoded by the facsimile communication section 12, to the non-resident directory of “RECEIVING TEMPORARY”.

After all image data has been loaded in the “RECEIVING TEMPORARY”, an identification number is assigned to the facsimile communication data according to the instruction from the control section 16. An non-resident directory corresponding to the identification number, for example, “NORMAL RECEIVING 001” is created in the image memory 18, and the facsimile communication data temporarily stored in the RECEIVING TEMPORARY” is moved to this non-resident directory (“NORMAL RECEIVING 001”).

This directory name consists of a combination between an identification number and receiving mode. This receiving mode includes a NORMAL RECEIVING mode and a MEMORY RECEIVING mode, as described above. For example, In the NORMAL RECEIVING mode where an image is outputted upon receipt of facsimile communication data, the received and decoded facsimile communication data is stored in the “RECEIVING TEMPORARY”. When confirmation has been made to see that all image data has been stored, the system moves to “NORMAL RECEIVING 001”, for example, and the data is stored in the sub-direction of “IMAGE 1-n” in units of image data.

In the MEMORY RECEIVING mode where facsimile communication data is processed-after having been stored, for example, the system moves to “MEMORY RECEIVING 001”, when confirmation has been made to see that all image data has been stored. Then the data is stored in the sub-direction of “IMAGE 1-n” in units of image data.

Subsequently, the following describes the procedure for creating a configuration electronic mail that is created by the control section as follows.

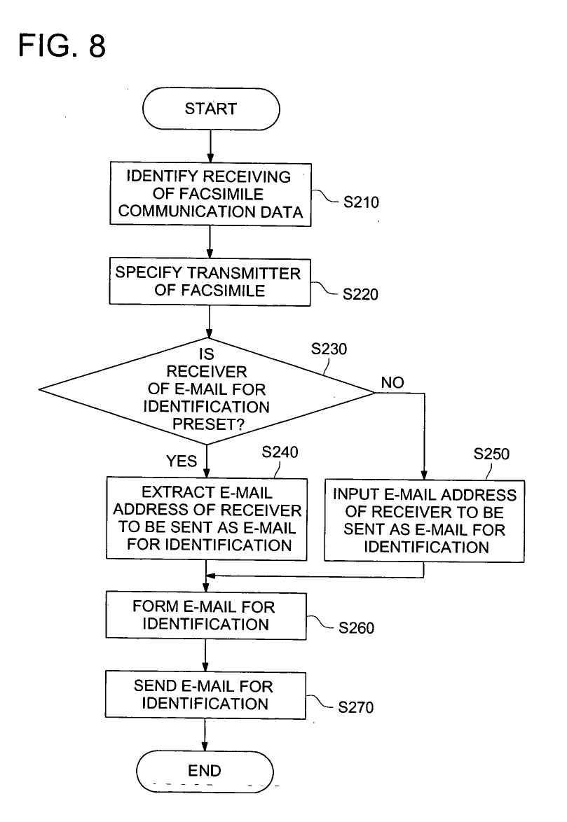

In step S210, as described above, reception of the facsimile communication data is identified by the control section 16, as shown in FIG. 8, and the system goes to step S220. In step S220, the transmitter of sending the received facsimile communication data is extracted by the control section 16.

In step S230, evaluation is made to determine if identification electronic mail has been preset or not. To put it another way, evaluation is made to determine whether or not an electronic mail address specified by default is present as the receiver, or whether or not a predetermined electronic mail address corresponding to a predetermined facsimile transmitter has been specified as a predetermined receiver.

If the result of this evaluation is YES, i.e. the receiver of the identification electronic mail has-been preset, the system goes to step S240. If the result of this evaluation is NO, i.e. the receiver of the identification electronic mail has not been preset, the system goes to step S250.

In step S240, the electronic mail address where the identification electronic mail is to be sent, is extracted from the aforementioned transmission table or specified memory, and the system proceeds to step S260.

In step S250, the electronic mail address where the identification electronic mail is to be sent is inputted by the manual input from the operation section 38, and the system proceeds to step S260.

In step S260, an identification electronic mail is created to notify a predetermined external terminal that facsimile communication data has been received, and the system proceeds to step S270.

This identification electronic mail comprises: a header portion 110 further including an electronic mail address (MAIL FROM) of the apparatus itself having received facsimile communication data; an electronic mail address of the receiver (MAIL TO) and the description of the electronic mail (DATA); and text 120 including the prompt for command input, as shown in FIG. 8.

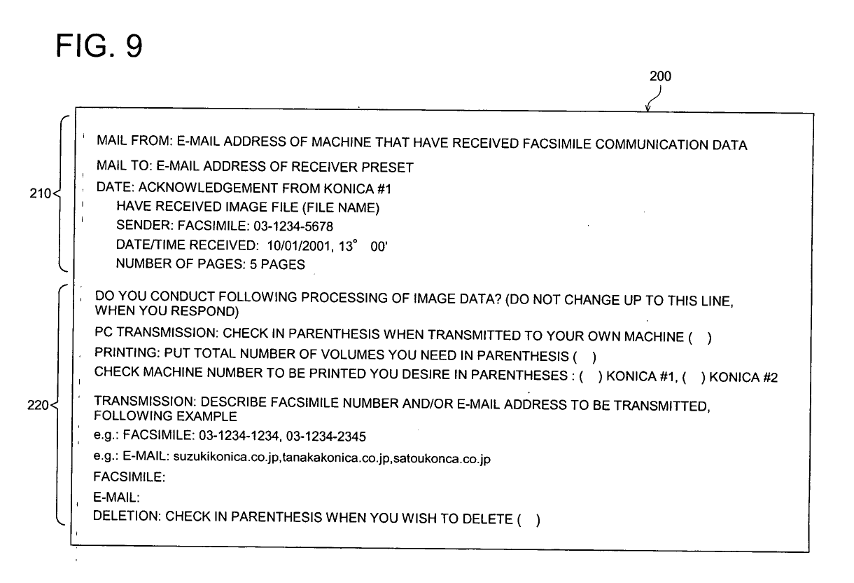

FIG. 9 shows that the electronic mail 200 of the header portion 210 contains information for notifying the reception of facsimile communication data, and it is the notification for reception of the facsimile communication data created by the apparatus “Konica #1”. The electronic mail 200 also contains the file name of the stored image, the telephone (facsimile) number of the transmitter, the date of reception and number of pages received.

The text 220 contains a “PC TRANSMISSION” mode, “PRINTING” mode, “TRANSMISSION” mode and “DELETION” mode, and a prompt appears to select one of these modes. When the “PC TRANSMISSION” mode is selected, facsimile communication data is sent to the external terminal having received an identification electronic mail. When the “PRINTING” mode is selected, facsimile communication data is outputted according to the number of copies and output apparatus inputted and specified in response to the prompt of the text 220. If the TRANSMISSION” mode is selected, facsimile communication data is transmitted according to the facsimile number and/or electronic mail address inputted and specified in response to the prompt of the text 220. Further, when the “DELETION” mode is selected, the facsimile communication data is deleted, accordingly.

Each mode selection is carried out in such a manner that after a predetermined input has been made according to the description of the identification electronic mail, a return mail is sent, alternatively, an electronic mail containing the similar description is created and sent, the electronic mail sent back is processed by the data processing section 14 and the command is extracted and then the control section 16 controls each component according to the command.

To put it more specifically, when the “PC TRANSMISSION” mode is selected, i.e. when it has been determined that a check mark is put in the CHECK column (parenthesis) of the “PC TRANSMISSION” as a result of the returned electronic mail having been processed by the data processing section 14, the control section 16 gives instructions to the image memory 18 to send the image data with an image file name shown in the header portion 210, to the data processing section 14. It gives instructions to the data processing section 14 to convert the image data having been sent, by, for example, reducing, enlarging or rotating thereof, for example, into a TIFF file format. Alternatively, this image data is converted into the TIFF file format by the control section 16, and an electronic mail containing this TIFF file is created by a personal computer as an external terminal. The mail is then sent through the network interface section.

When the “PRINTING” mode is selected, i.e. when it has been determined that a check mark is put in the CHECK column (parenthesis) of the “PC TRANSMISSION” as a result of the returned electronic mail having been processed by the data processing section 14, if there is any numeral immediately before the check column, the control section 16 gives instructions to the data processing section 14 to assume this numeral as the number of bundle of copies to be outputted. The data processing section 14 sends to the recording section 34 the image data to be outputted, and this instruction is given. Based on this instruction, the recording section 34 forms an image from the image data and outputs it.

When the “TRANSMISSION” mode is selected, i.e. when it has been determined that the telephone number or electronic mail has been input in the input column of the “TRANSMISSION”, namely in the space delimited by a comma or a line break as a result of the returned electronic mail having been processed by the data processing section 14, the control section 16 gives instructions to the image memory 18 to send to the data processing section 14 the image data to be processed. If a telephone number is inputted, the control section 16 gives-instructions to the data processing section 14 to send the image data to the facsimile communication section 12. The facsimile communication section 12 encrypts the image data into the code for facsimile communication data, and sends it to the external apparatus 42 through the telephone line 50. When there is an electronic mail input, the control section 16 gives instructions to the data processing section 14 to convert the image data into a predetermined file format, for example, into the TIFF formant, and to send it to the control section 16. The electronic mail with the converted data attached thereto is created, and is sent to a predetermined external terminal through the network interface section 22.

As described above, when having received facsimile communication data, the aforementioned image forming apparatus notifies an external terminal of such reception through identification electronic mail, without image data being sent, thereby eliminating the need of unwanted image data transmission. Further, upon receipt of an identification electronic mail, the external terminal returns an instruction electronic mail with a predetermined command described thereon, thereby permitting remote processing of the image data from the external terminal. This ensures easy change of the identification electronic mail receiver to a desired destination by the operator of the external terminal.

The present invention allows specified processing of a received facsimile such as outputting and transfer to be carried out according to the instruction given by remote control from the receiver side, and permits processing conditions to be changed in a flexible manner.

What is claimed is:

1. An image forming apparatus comprising:
(a) a communication device for communicating with an external apparatus according to a communication procedure by a facsimile;
(b) a data processor for picking up image data and communication control data by decoding facsimile communication data from the external apparatus received by the communication device;
(c) a memory for storing the image data obtained by the data processor, by associating with identification data to identify the image data;
(d) an image output device for forming and outputting an image based on the image data;
(e) an identification electronic mail creating device for creating an identification electronic mail for demanding an image data processing format to be set, by notifying that, when communication control data has been obtained by the data processor, facsimile communication data to be sent to a predetermined electronic mail address has been received, and also by notifying image data identification data;
(f) a transmission and reception device for transmitting the identification electronic mail to a predetermined external terminal and for receiving an instruction electronic mail containing an instruction on a processing format for the image data and the identification data from the external terminal;
(g) an electronic mail processor for extracting the instruction on the image data processing format and the identification data from the instruction electronic mail from the external terminal; and
(h) an image data processor for sending to the image output device an output image data which is obtained by processing so that the image data specified according to the extracted processing format is outputted according to the processing format.

2. The image forming apparatus of claim 1, further comprising a transmission table for storing an electronic mail address in association with the transmitter of the facsimile communication data included in the communication control data,
wherein the identification electronic mail device extracts the electronic mail address where the identification electronic mail is sent by referring to the transmission table based on the transmitter to create the identification electronic mail.

3. The image forming apparatus of claim 1, further comprising a processing table for storing a transmitter of the facsimile communication data included in the communication control data, and information on whether the image data corresponding to the communication control data should be sent to the image output device or the memory,
wherein the data processor sends the image data to a predetermined receiver by referring to the processing table, based on the transmitter.

4. The image forming apparatus of claim 1, further comprising an input device for specifying a voluntary receiver to which an identification electronic mail is sent, when the identification electronic mail creating device creates the identification electronic mail.

5. The image forming apparatus of claim 1, further comprising a deletion device for deleting the image data output.

6. The image forming apparatus of claim 5, wherein image data processing format is one of printing, facsimile sending, e-mail sending and deleting, or a combination thereof.
